(19) United States
(12) Patent Application Publication
(10) Pub. No.: US 2025/0147739 A1
(43) Pub. Date: May 8, 2025

(54) ENVIRONMENT CONSTRUCTION SUPPORT APPARATUS, SYSTEM, AND METHOD, AND COMPUTER-READABLE MEDIUM

(71) Applicant: NEC Corporation, Minato-ku, Tokyo (JP)

(72) Inventor: Toru WAKITANI, Tokyo (JP)

(73) Assignee: NEC Corporation, Minato-ku, Tokyo (JP)

(21) Appl. No.: 18/837,938

(22) PCT Filed: Feb. 28, 2022
(86) PCT No.: PCT/JP2022/008392

§ 371 Date: Aug. 13, 2024

(51) Int. Cl. G06F 8/36

(52) U.S. Cl. CPC G06F 8/36

(57) ABSTRACT

An environment construction support apparatus includes a reception unit that receives selection of a notation related to a processing purpose in a predetermined environment construction tool in an information system, a specifying unit that specifies, for each of the processing purposes in the environment construction tool, a first set corresponding to the selected notation from first registration information in which a set of a code character string that can be described for execution by the environment construction tool and an accompanying character string that can be described accompanying the code character string is registered, a generation unit that generates a template code to be executed by the selected environment construction tool by using the code character string and the accompanying character string included in the specified first set, and a display unit that displays the generated template code in a code display field of a screen.

### TECHNICAL FIELD

The present invention relates to an environment construction support apparatus, a system, a method, and a program.

### BACKGROUND ART

In recent years, a technique called infrastructure as code (IaC) is becoming widespread as a technique for automating environment construction of an information system. An environment construction tool (or orchestrator) that implements IaC executes environment construction processing using a program code called an IaC code. The IaC code is a script file in which the environment construction processing, setting values for each environment, and the like are described.

Patent Literature 1 discloses a technique related to an environment construction support system. The environment construction support system requires a constant design document or a definition file template described according to a format and definition of a specific environment construction tool. The conversion tool provided by the environment construction tool converts a constant design document, a definition file template, and the like into a constant setting value file of a predetermined format. The environment construction tool generates a definition file and a construction script by using the converted constant setting value file as an input. Then, the environment construction support system executes the generated definition file and construction script on the construction target server to construct the environment.

Patent Literature 2 discloses a technique related to a system construction parameter management system. The system collects system definition information defining an operation environment of a target system, extracts a parameter from the system definition information, and updates a parameter in an existing IaC code to the extracted parameter.

### CITATION LIST

### Patent Literature

Patent Literature 1: Japanese Unexamined Patent Application Publication No. 2020-017053
Patent Literature 2: Japanese Unexamined Patent Application Publication No. 2020-061019

### SUMMARY OF INVENTION

### Technical Problem

Here, in the environment construction tool, frequency of version upgrade is high, and the specification of the syntax of the IaC code is often changed every time the version upgrade is executed. Therefore, as the version of the environment construction tool is upgraded, an engineer corrects the IaC code, and there is a problem that maintenance is complicated. For example, in the technique according to Patent Literature 1, maintenance of setting items and the like of a definition file in a constant design document and a definition file template can be complicated. Note that the technology according to Patent Literature 2 is a technology for updating a parameter of a created IaC code, and does not consider specification change of a syntax of the IaC code due to version change of an environment construction tool.

In view of the above-described problems, an object of the present disclosure is to provide an environment construction support apparatus, system, method, and program for supporting efficient creation of an IaC code according to an environment construction tool.

### Solution to Problem

An environment construction support apparatus according to a first aspect of the present disclosure includes:
a reception means for receiving selection of a notation related to a processing purpose in a predetermined environment construction tool in an information system;
a specifying means for specifying, for each of the processing purposes in the environment construction tool, a first set corresponding to the selected notation from first registration information in which a set of a code character string that can be described for execution by the environment construction tool and an accompanying character string that can be described accompanying the code character string is registered;
a generation means for generating a template code to be executed by the selected environment construction tool by using the code character string and the accompanying character string included in the specified first set; and
a display means for displaying the generated template code in a code display field of a screen.

An environment construction support system according to a second aspect of the present disclosure includes:
a storage device configured to store first registration information in which a set of a code character string that can be described for execution by a predetermined environment construction tool in an information system and an accompanying character string that can be described accompanying the code character string is registered for each processing purpose in the environment construction tool; and
an environment construction support apparatus connected to the storage device,
in which the environment construction support apparatus includes
a reception means for receiving selection of a notation related to the processing purpose in the predetermined environment construction tool,
a specifying means for specifying a first set corresponding to the selected notation from the first registration information,
a generation means for generating a template code to be executed by the selected environment construction tool by using the code character string and the accompanying character string included in the specified first set, and
a display means for displaying the generated template code in a code display field of a screen.

An environment construction support method performed by a computer according to a third aspect of the present disclosure includes:
receiving selection of a notation related to a processing purpose in a predetermined environment construction tool in an information system;
specifying, for each of the processing purposes in the environment construction tool, a first set corresponding to the selected notation from first registration information in which a set of a code character string that can be described for execution by the environment construction tool and an accompanying character string that can be described accompanying the code character string is registered;
generating a template code to be executed by the selected environment construction tool by using the code character string and the accompanying character string included in the specified first set; and
displaying the generated template code in a code display field of a screen.

An environment construction support program according to a fourth aspect of the present disclosure causes a computer to execute:
reception processing of receiving selection of a notation related to a processing purpose in a predetermined environment construction tool in an information system;
specifying processing of specifying, for each of the processing purposes in the environment construction tool, a first set corresponding to the selected notation from first registration information in which a set of a code character string that can be described for execution by the environment construction tool and an accompanying character string that can be described accompanying the code character string is registered;
generation processing of generating a template code to be executed by the selected environment construction tool by using the code character string and the accompanying character string included in the specified first set; and display processing of displaying the generated template code in a code display field of a screen.

### Advantageous Effects of Invention

According to the present disclosure, it is possible to provide an environment construction support apparatus, system, method, and program for supporting efficient creation of an IaC code according to an environment construction tool.

### BRIEF DESCRIPTION OF DRAWINGS

FIG. 1 is a block diagram illustrating a configuration of an environment construction support apparatus according to a first example embodiment.

FIG. 2 is a flowchart illustrating a flow of an environment construction support method according to the first example embodiment.

FIG. 3 is a block diagram illustrating a configuration of an environment construction support system according to a second example embodiment.

FIG. 4 is a block diagram illustrating a configuration of an environment construction support apparatus according to the second example embodiment.

FIG. 5 is a diagram illustrating an example of a tool list according to the second example embodiment.

FIG. 6 is a diagram illustrating an example of module registration information according to the second example embodiment.

FIG. 7 is a diagram illustrating an example of support option registration information according to the second example embodiment.

FIG. 8 is a flowchart illustrating a flow of IaC code creation support processing according to the second example embodiment.

FIG. 9 is a diagram illustrating an example of an IaC code creation support screen according to the second example embodiment.

FIG. 10 is a diagram illustrating an example of an IaC code creation support screen according to the second example embodiment.

### EXAMPLE EMBODIMENT

Hereinafter, example embodiments of the present disclosure will be described in detail with reference to the drawings. In the drawings, the same or corresponding elements are denoted by the same reference numerals, and redundant description is omitted as necessary for clarity of description.

### First Example Embodiment

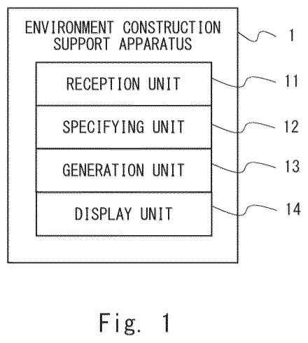

FIG. 1 is a block diagram illustrating a configuration of an environment construction support apparatus 1 according to a first example embodiment. The environment construction support apparatus 1 is an information processing apparatus for supporting environment construction of an information system. The environment construction support apparatus 1 includes a reception unit 11, a specifying unit 12, a generation unit 13, and a display unit 14.

The reception unit 11 receives selection of a notation related to a processing purpose in a predetermined environment construction tool in the information system. For example, the reception unit 11 may receive the notation selected by a user. Here, the “information system” includes one or more servers, network devices, storage devices, and the like. Furthermore, the “information system” is constructed on a system environment that is an on-premises, a cloud infrastructure, a virtual infrastructure, or a combination thereof. The “environment construction tool” is software for performing environment construction processing of the information system on a system environment. The “environment construction tool” executes the environment construction processing using a program code called an IaC code. The “processing purpose” indicates the purpose of various types of processing executed by the environment construction tool. The “notation related to the processing purpose” is display information indicating the processing purpose, a character string (code character string) of a program code corresponding to the processing purpose, and the like.

The specifying unit 12 specifies a first set corresponding to the selected notation from the first registration information. Here, the “first registration information” is information in which a set of a code character string and an accompanying character string is registered for each processing purpose in the environment construction tool. The “code character string” is a character string of a program code that can be described to be executed by the environment construction tool. The “accompanying character string” is a character string of a program code that can be described accompanying the code character string.

The generation unit 13 generates a template code to be executed by the selected environment construction tool, using the code character string and the accompanying character string included in the specified first set. Here, the “template code” is a partial description of the IaC code. That is, the “template code” is an uncompleted IaC code before a setting value or the like unique to the environment at the time of environment construction is input. The display unit 14 displays the generated template code in the code display field of the screen.

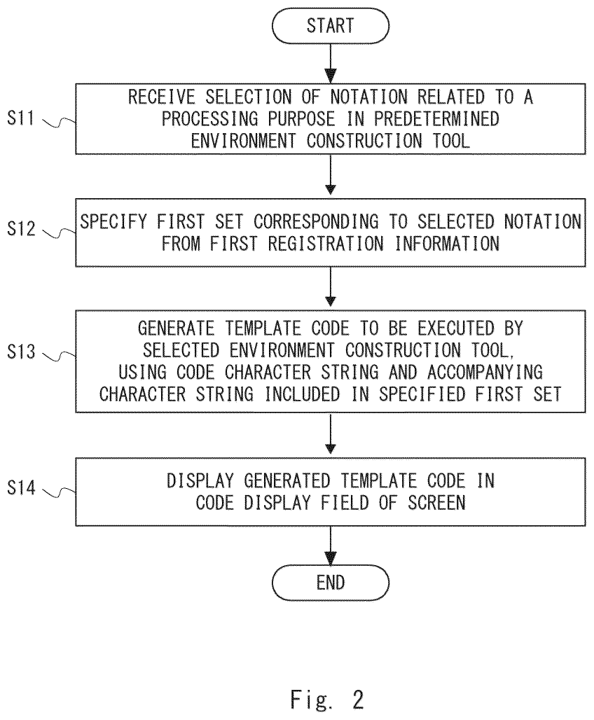

FIG. 2 is a flowchart illustrating a flow of an environment construction support method according to the first example embodiment. First, the reception unit 11 receives selection of a notation related to a processing purpose in a predetermined environment construction tool (S11). Next, the specifying unit 12 specifies a first set corresponding to the selected notation from the first registration information (S12). Then, the generation unit 13 generates a template code to be executed by the selected environment construction tool, using the code character string and the accompanying character string included in the specified first set (S13). Thereafter, the display unit 14 displays the generated template code in the code display field of the screen (S14).

As described above, the environment construction support apparatus 1 according to the present example embodiment complements and displays the character string of the program code that can be described by the environment construction tool according to the notation related to the processing purpose in the predetermined environment construction tool selected by the person in charge of creating the IaC code, for example. Therefore, the person in charge of creating the IaC code can create the IaC code according to the environment construction tool without knowing the syntax, description rule, and the like that can be executed by the environment construction tool. Therefore, according to the present example embodiment, it is possible to support efficient creation of the IaC code according to the environment construction tool.

Note that the environment construction support apparatus 1 includes a processor, a memory, and a storage device as components (not illustrated). In addition, the storage device stores a computer program in which the processing of the environment construction support method according to the present example embodiment is implemented. Then, the processor reads a computer program or the like from the storage device into the memory, and executes the computer program. As a result, the processor implements the functions of the reception unit 11, the specifying unit 12, the generation unit 13, and the display unit 14.

Alternatively, each component of the environment construction support apparatus 1 may be implemented by dedicated hardware. In addition, some or all of the components of each device may be realized by general-purpose or dedicated circuitry, a processor, or the like, or a combination thereof. These may be configured by a single chip or may be configured by a plurality of chips connected via a bus. Some or all of the components of each device may be realized by a combination of the above-described circuitry or the like and a program. Furthermore, as the processor, a central processing unit (CPU), a graphics processing unit (GPU), a field-programmable gate array (FPGA), a quantum processor (quantum computer control chip), or the like can be used.

### Second Example Embodiment

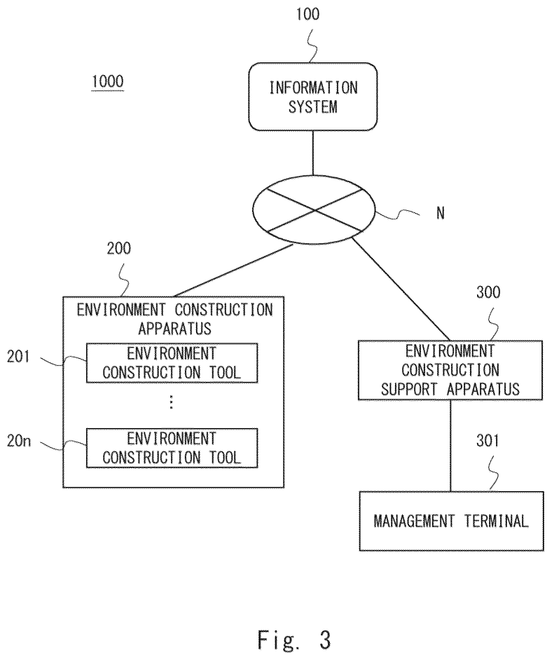

A second example embodiment is a specific example of the first example embodiment described above. FIG. 3 is a block diagram illustrating the configuration of an environment construction support system 1000 according to the second example embodiment. The environment construction support system 1000 is an information system for supporting environment construction of the information system 100. The environment construction support system 1000 includes an information system 100, an environment construction apparatus 200, an environment construction support apparatus 300, and a management terminal 301. The information system 100, the environment construction apparatus 200, and the environment construction support apparatus 300 are connected via a network N. The network N is a communication network including a wireless communication line network, a mobile phone line network, and the like. The network N may include the Internet. The communication network may be of any type of communication protocol. The information system 100 is an information system at the time of development, test, operation, or the like.

The environment construction apparatus 200 is an information processing apparatus including environment construction tools 201 to 20n (n is a natural number of 2 or more). Examples of the environment construction tool 201 and the like include, but are not limited to, Ansible (registered trademark), Teraform, and the like. The environment construction apparatus 200 receives designation of an environment construction tool and input of an IaC code from the environment construction support apparatus 300, and causes the designated environment construction tool to execute the IaC code. As a result, an environment of the information system 100 is constructed.

The environment construction support apparatus 300 is an example of the environment construction support apparatus 1 described above. The environment construction support apparatus 300 is an information processing apparatus for supporting environment construction of the information system 100. The environment construction support apparatus 300 may be made redundant by a plurality of computers, and each functional block may be realized by a plurality of computers.

The management terminal 301 is a terminal device operated by a person in charge of creating the IaC code, an administrator of the environment construction tool, or the like, and is, for example, a personal computer or the like. The management terminal 301 is communicably connected to the environment construction support apparatus 300 via a network or the like, and accesses the environment construction support apparatus 300 according to an operation of an administrator or the like to input information or the like. Note that the management terminal 301 may also be connected to the environment construction apparatus 200 and the network N.

Note that the environment construction apparatus 200 may include at least one environment construction tool. That is, the environment construction apparatus 200 may be realized by a plurality of computers. Alternatively, some or all of the environment construction apparatus 200, the environment construction support apparatus 300, and the management terminal 301 may be configured by the same hardware. Alternatively, the environment construction apparatus 200 and the environment construction support apparatus 300 may be made redundant by a plurality of computers. Furthermore, a plurality of management terminals 301 may be provided.

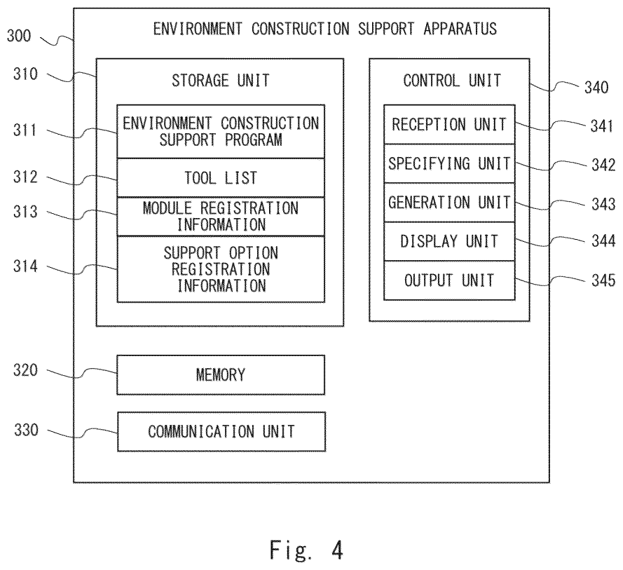

FIG. 4 is a block diagram illustrating a configuration of the environment construction support apparatus 300 according to the second example embodiment. The environment construction support apparatus 300 includes a storage unit 310, a memory 320, a communication unit 330, and a control unit 340. The storage unit 310 is an example of a storage device such as a hard disk or a flash memory. The storage unit 310 stores an environment construction support program 311, a tool list 312, module registration information 313, and support option registration information 314. The environment construction support program 311 is a computer program in which environment construction support processing and the like according to the second example embodiment are implemented.

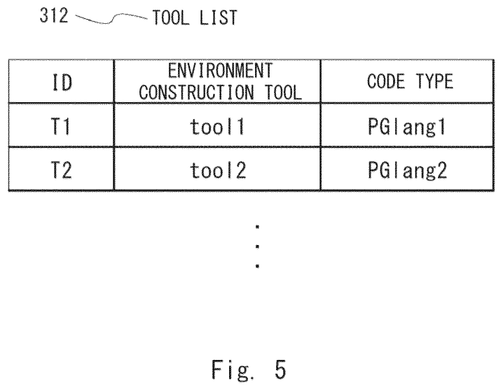

The tool list 312 is a list of environment construction tools for which the environment construction support apparatus 300 supports the IaC code creation. FIG. 5 is a diagram illustrating an example of the tool list 312 according to the second example embodiment. The tool list 312 is information in which an ID, an environment construction tool (name), a code type, and the like are associated. The code type is a type of programming language executable by the corresponding environment construction tool. For example, in a case where the environment construction tool is Ansible (registered trademark), the code type is playbook described in YAML (YAML Ain't Markup Language), and in a case where the environment construction tool is Teraform, the code type is HCL (HashiCorp Configuration Language), but is not limited thereto. In addition, the tool list 312 may further associate an environment construction tool, a version of a code type, a syntax rule in the code type, a description rule (coding rule), and the like.

Returning to FIG. 4, the description will be continued.

The module registration information 313 is an example of the first registration information described above. The module registration information 313 is information in which a set of a code character string and an accompanying character string defined for a code type of each environment construction tool is registered for each processing purpose in a plurality of environment construction tools. The “code character string” is referred to as a “module” depending on the code type, and thus is hereinafter referred to as a “main module”. The “accompanying character string” includes an option character string that can be specified by the main module and a connection character string for connecting the option and the setting value.

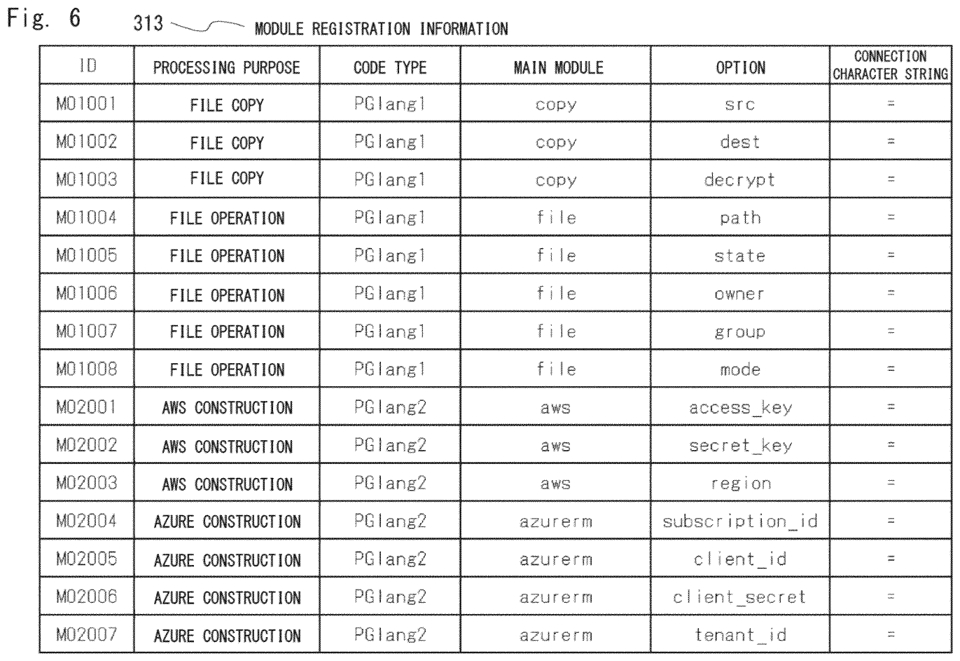

FIG. 6 is a diagram illustrating an example of the module registration information 313 according to the second example embodiment. The module registration information 313 is information in which an ID, a processing purpose, a code type, a main module, an option, a connection character string, and the like are associated. The processing purpose is notation indicating the purpose of processing in the environment construction tool and the code type. The main module is notation of a code character string that can be described by a code type in a corresponding processing purpose. The option is a notation of an option character string. The connection character string is a notation of a character string for connecting the option and the setting value.

Returning to FIG. 4, the description will be continued.

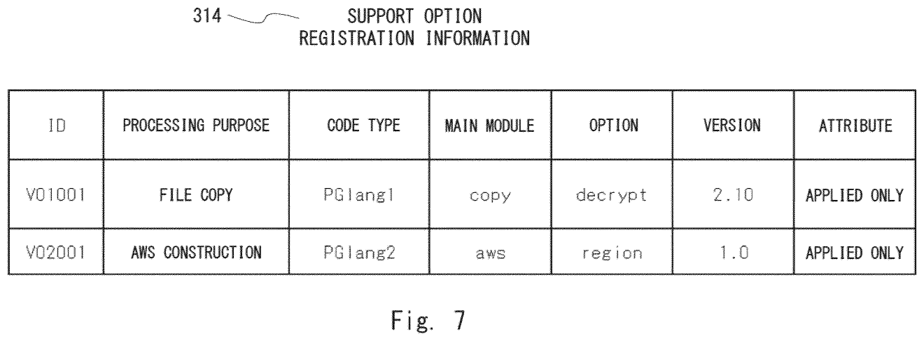

The support option registration information 314 is an example of second registration information. The support option registration information 314 is information in which a set of a code character string and an accompanying character string supported by a specific version in the environment construction tool is registered. FIG. 7 is a diagram illustrating an example of the support option registration information 314 according to the second example embodiment. The support option registration information 314 is information in which an ID, a processing purpose, a code type, a main module, an option, a version, an attribute, and the like are associated. The “version” is a code type or a version number or the like supported by the environment construction tool associated with the code type. The “attribute” is information indicating whether the supported version is “applied only”, the version is “applied after”, the version is “applied until”, or the like. Alternatively, the “attribute” may be information indicating “not applicable” or “not supported” in the version.

Returning to FIG. 4, the description will be continued.

The memory 320 is a volatile storage device such as a random access memory (RAM), and is a storage area for temporarily holding information during the operation of the control unit 340. The communication unit 330 is a communication interface between the inside and the outside of the environment construction support apparatus 300.

The control unit 340 is a processor that controls each component of the environment construction support apparatus 300, that is, a control apparatus. The control unit 340 reads the environment construction support program 311 from the storage unit 310 into the memory 320, and executes the environment construction support program 311. As a result, the control unit 340 implements the functions of the reception unit 341, the specifying unit 342, the generation unit 343, the display unit 344, and the output unit 345.

The reception unit 341 is an example of the reception unit 11 described above. The reception unit 341 receives one of a plurality of environment construction tools as selection of a predetermined environment construction tool from an IaC code creation screen to be described later. Further, the reception unit 341 receives selection of a version in the selected predetermined environment construction tool from the IaC code creation screen. In addition, the reception unit 341 receives selection of a notation related to a processing purpose in the selected environment construction tool from the processing purpose selection field in the IaC code creation screen.

The specifying unit 342 is an example of the specifying unit 12 described above. The specifying unit 342 specifies notation of one or more processing purpose candidates associated with the selected environment construction tool from the module registration information 313. Alternatively, the specifying unit 342 may specify one or more code character strings corresponding to the selected environment construction tool from the module registration information 313 as notation related to the processing purpose candidate. As a result, a creator can create the IaC code while imagining coding. In addition, the specifying unit 342 specifies a first set corresponding to the selected notation from the module registration information 313. Specifically, the specifying unit 342 specifies the main module, the option, and the connection character string associated with the processing purpose selected from the processing purpose selection field. Alternatively, the specifying unit 342 specifies an option and a connection character string associated with the main module selected from the processing purpose selection field. Further, the specifying unit 342 specifies a second set corresponding to the selected version in the predetermined environment construction tool from the support option registration information 314.

The generation unit 343 is an example of the generation unit 13 described above. The generation unit 343 generates the IaC code creation screen for initial display in response to the IaC code creation request from the management terminal 301. The IaC code creation screen for initial display includes at least an environment construction tool selection field and a version selection field. In addition, the generation unit 343 generates a template code to be executed by the selected environment construction tool, using the code character string and the accompanying character string included in the specified first set. Further, the generation unit 343 generates the template code by excluding the accompanying character string in the code character string included in the specified second set. This allows option character strings that are not supported in a specific version to be excluded from the template code. Therefore, the user can easily describe the necessary options even when the user is not familiar with the support status of the options of the respective versions of the various environment construction tools. In addition, the generation unit 343 generates the template code so as to satisfy the description rule in the predetermined environment construction tool. As a result, the user can easily satisfy the description requirement operable by the predetermined environment construction tool without checking the coding rules of various environment construction tools, the target information system, and the usage project each time.

The display unit 344 is an example of the display unit 14 described above. The display unit 344 transmits the IaC code creation screen generated in response to the IaC code creation request from the management terminal 301 to the management terminal 301, and causes the management terminal 301 to display the IaC code creation screen. In addition, the display unit 344 makes the notation related to the specified candidate for the processing purpose selectable and displays the notation in the processing purpose selection field in the IaC code creation screen. In addition, the display unit 344 displays the generated template code in a code display field in the IaC code creation screen. At this time, the display unit 344 may display the template code in the code display field in an editable manner. In addition, when accepting the selection of the notation, the display unit 344 adds the notation to the processing flow display field in the IaC code creation screen and displays the same.

In response to an output request from a predetermined request source, the output unit 345 outputs the content displayed in the code display field to the request source. For example, the output unit 345 causes the management terminal 301 to download the edited template code displayed in the code display field.

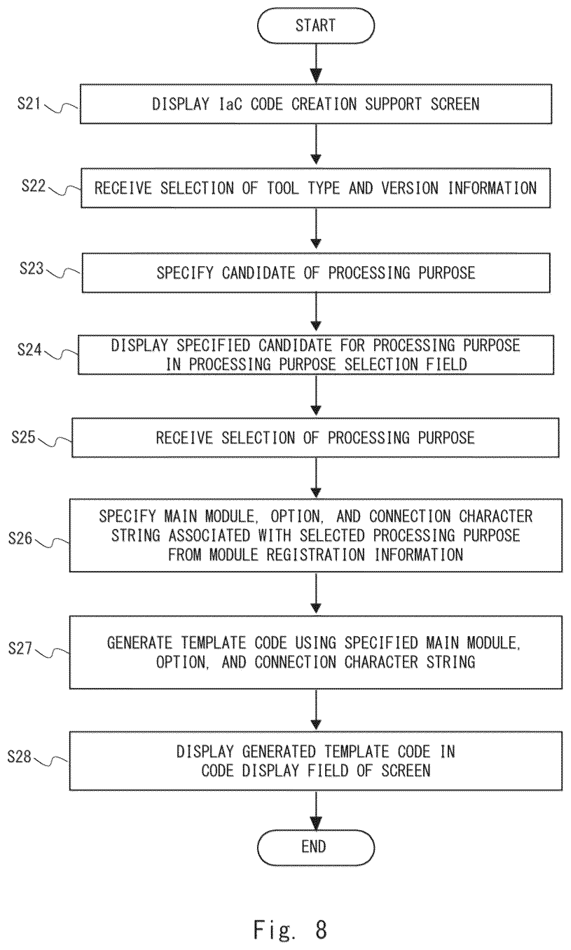

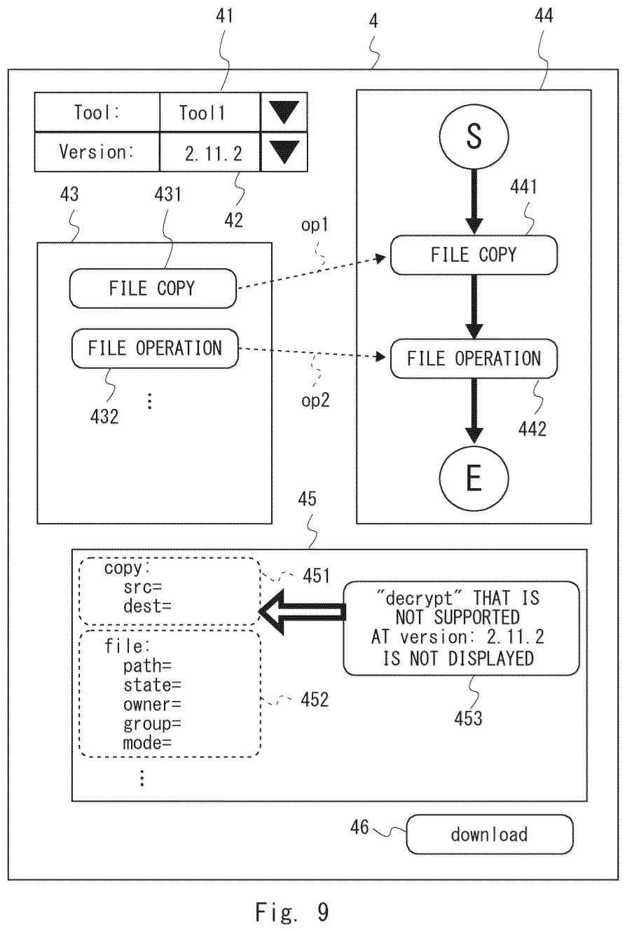

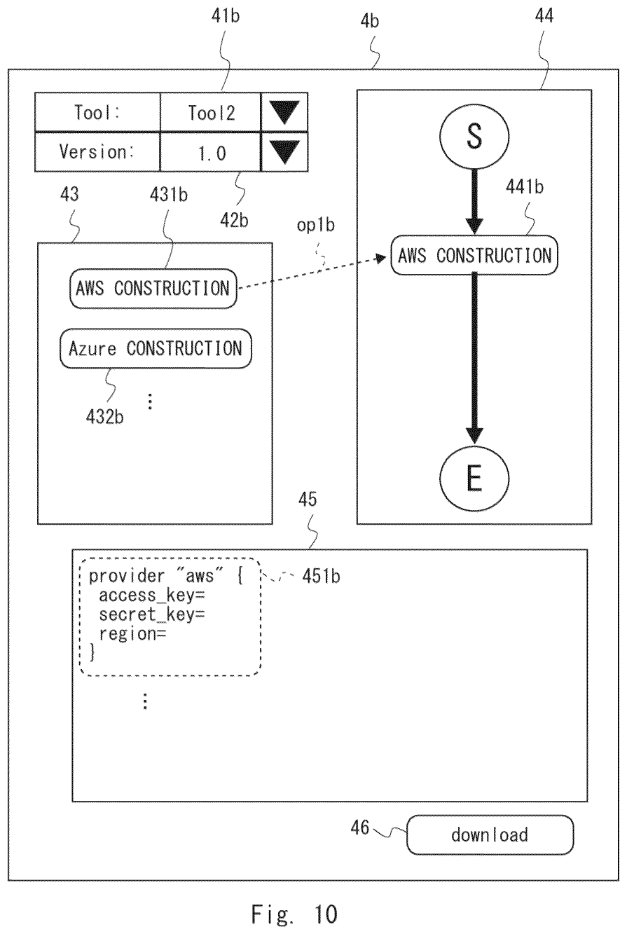

FIG. 8 is a flowchart illustrating a flow of the IaC code creation support processing according to the second example embodiment. Note that, in the following description, FIGS. 9 and 10 are appropriately referred to.

First, the management terminal 301 transmits the IaC code creation request to the environment construction support apparatus 300 according to the operation of the person in charge of creating the IaC code. In response to this, the generation unit 343 of the environment construction support apparatus 300 generates the IaC code creation screen for initial display. Then, the display unit 344 transmits the generated IaC code creation screen to the management terminal 301, and causes the management terminal 301 to display the IaC code creation screen (S21).

FIG. 9 is a diagram illustrating an example of an IaC code creation support screen 4 according to the second example embodiment. The IaC code creation support screen 4 includes an environment construction tool selection field 41, a version selection field 42, a processing purpose selection field 43, a processing flow display field 44, an IaC code display field 45, and a download button 46.

At the time of Step S21, that is, at the stage of initial display, the IaC code creation support screen 4 only needs to display at least the environment construction tool selection field 41 and the version selection field 42. At this time, the display contents of the environment construction tool selection field 41, the version selection field 42, and the like may be empty (unselected), or a default value may be displayed. Furthermore, at this time, the display content in the processing purpose selection field 43 may be empty or may be a display content according to the default value of the environment construction tool selection field 41. In addition, at this time point, in the processing flow display field 44, it is assumed that the processing 441 and 442 is not displayed, and the display content of the IaC code display field 45 is empty.

The environment construction tool selection field 41 is a field in which the name of the environment construction tool in the tool list 312 can be selected by pull-down. The version selection field 42 is a field allowing selection of a version number supported by the environment construction tool selected in the environment construction tool selection field 41. That is, the list of version numbers selectable in the version selection field 42 is dynamically changed according to the type of environment construction tool selected in the environment construction tool selection field 41.

The processing purpose selection field 43 is a field in which a notation related to one or more processing purpose candidates corresponding to the environment construction tool (code type) selected in the environment construction tool selection field 41 is displayed and a selection operation is received. The processing flow display field 44 is a field for displaying the notation selected in the processing purpose selection field 43 in the processing flow. The IaC code display field 45 is a field for displaying a template code corresponding to the notation selected in the processing purpose selection field 43 and the version selected in the version selection field 42. Note that the code may be editable in the IaC code display field 45. When pressed, the download button 46 is a button for executing processing of downloading the contents displayed in the IaC code display field 45.

Next, the management terminal 301 receives selection of the tool type and the version information according to the operation of the person in charge of creation (S22). For example, the person in charge of creation selects “Tool1” from the environment construction tool selection field 41 via the management terminal 301, and selects “2.11.2” from the version selection field 42. In response to this, the management terminal 301 transmits the selection content in the environment construction tool selection field 41 as the tool type and the selection content in the version selection field 42 as the version information to the environment construction support apparatus 300. Then, the reception unit 341 receives selection of the tool type and the version information from the management terminal 301.

Then, the specifying unit 342 specifies a candidate for the processing purpose (S23). Specifically, the specifying unit 342 refers to the tool list 312 and specifies a code type corresponding to the selected tool type. Then, the specifying unit 342 specifies the notation of the processing purpose associated with the specified code type from the module registration information 313. For example, in the case of the environment construction tool (tool type) “Tool1”, the specifying unit 342 specifies the code type “PGlang1” and specifies the processing purposes “file copy” and “file operation” as candidates of the processing purpose.

Then, the display unit 344 makes the notation related to the specified candidate for the processing purpose selectable and displays the notation in the processing purpose selection field 43 in the IaC code creation screen 4 (S24). In the example of FIG. 9, “file copy” is displayed as a processing purpose notation 431 and “file operation” is displayed as a processing purpose notation 432 in the processing purpose selection field 43.

Thereafter, the management terminal 301 receives a processing purpose selection operation for the processing purpose selection field 43 from the person in charge of creation. For example, the management terminal 301 receives a selection operation op1 of the processing purpose notation 431 by the person in charge of creation. The selection operation op1 may be, for example, drag and drop to the processing flow display field 44. In response to this, the management terminal 301 transmits, to the environment construction support apparatus 300, the fact that the processing purpose notation 431 has been selected and the fact that the processing purpose notation has been dragged and dropped between “S” and “E” in the processing flow display field 44. Then, the reception unit 341 receives selection of a processing purpose from the management terminal 301 (S25). Here, the reception unit 341 receives that “file copy” is selected as the processing purpose and that “file copy” is dragged and dropped between “S” and “E” in the processing flow display field 44.

In response to this, the specifying unit 342 specifies the main module, the option, and the connection character string associated with the selected processing purpose from the module registration information 313 (S26). For example, the specifying unit 342 specifies the main module “copy”, the options “src”, “dest”, “decrypt”, and the connection character string “=” associated with the processing purpose “file copy”. In addition, the specifying unit 342 specifies a main module and an option (and attribute) corresponding to the selected tool type and version from the support option registration information 314. For example, the specifying unit 342 specifies the main module “copy”, the option “decrypt”, and the attribute “apply only” associated with the processing purpose “file copy” and the version “2.10”.

Then, the generation unit 343 generates the template code using the specified main module, option, and connection character string (S27). Specifically, first, the specifying unit 342 specifies a half-width space, a colon character, and the like according to the coding rule defined in the environment construction tool “Tool1” and the code type “PGlang1”. Then, the generation unit 343 determines that the option “decrypt” cannot be specified as the main module “copy” from the version “2.11.2” selected in the version selection field 42 and the version “2.10” and the attribute “apply only” specified from the support option registration information 314. Therefore, the generation unit 343 generates the template code using the main module “copy”, the options “src” and “dest”, the connection character string “=”, and the half-width space, the colon character, and the like according to the coding rule. That is, the generation unit 343 generates the template code by excluding the option “decrypt” that is not supported in the selected version.

Thereafter, the display unit 344 displays the generated template code in the code display field of the screen (S28). Specifically, the display unit 344 transmits the template code to the management terminal 301. In response to this, the management terminal 301 displays as the template code 451 in the IaC code display field 45 of the IaC code creation support screen 4. As indicated by a non-display reason 453, the option “decrypt” is not displayed in the template code 451. However, the non-display reason 453 itself is a description for describing the effect of the present example embodiment, and may not be an example of screen display.

At the same time, that is, in response to the selection operation op1, the generation unit 343 generates the notation of the processing 441 “file copy”, and the display unit 344 displays the notation of the processing 441 in the processing flow display field 44.

Thereafter, the management terminal 301 continuously receives a selection operation op2 of the processing purpose notation 432 by the person in charge of creation. Here, it is assumed that the selection operation op2 is a drag and drop to an area below the processing 441 in the processing flow display field 44.

In response to this, Steps S25 to S28 described above are executed. For example, the specifying unit 342 specifies the main module “file”, the options” path”, “state”, “owner”, “group”, “mode”, and the connection character string “=” associated with the processing purpose “file operation”. In addition, the specifying unit 342 searches for a record associated with the processing purpose “file operation” and the version “2.10” from the support option registration information 314, but cannot specify the record since it does not exist in the example of FIG. 7. Then, the generation unit 343 generates the template code using the main module “file”, the options “path”, “state”, “owner”, “group”, “mode”, the connection character string “=”, a half-width space according to the coding rule, a colon character, and the like. The display unit 344 transmits the generated template code to the management terminal 301. In response to this, the management terminal 301 displays as the template code 452 in the IaC code display field 45 of the IaC code creation support screen 4. At the same time, that is, in response to the selection operation op2, the generation unit 343 generates the notation of the processing 442 “file operation”, and the display unit 344 displays the notation of the processing 442 under the processing 441 in the processing flow display field 44.

Thereafter, for example, the management terminal 301 may update the display content according to an editing operation on the code displayed in the IaC code display field 45 from the person in charge of creation. In addition, when accepting the pressing of the download button 46 from the person in charge of creation, the management terminal 301 downloads the edited template code displayed in the IaC code display field 45 to the management terminal 301. Alternatively, when accepting the pressing of the download button 46, the management terminal 301 may transmit the fact and the display content currently displayed in the IaC code display field 45 to the environment construction support apparatus 300. In this case, the output unit 345 of the environment construction support apparatus 300 transmits the received display content to the management terminal 301. As a result, the management terminal 301 can store the IaC code being edited in the IaC code display field 45 inside as a text file. Then, the person in charge of creation can continue to edit the IaC code to create and complete a desired IaC code.

FIG. 10 is a diagram illustrating an example of an IaC code creation support screen 4b according to the second example embodiment. The IaC code creation support screen 4b is an example in which an environment construction tool to be selected is different from that of the above-described IaC code creation support screen 4. The IaC code creation support screen 4b includes an environment construction tool selection field 41b, a version selection field 42b, a processing purpose selection field 43, a processing flow display field 44, an IaC code display field 45, and a download button 46. “Tool 2” is selected as an environment construction tool (tool type) in the environment construction tool selection field 41b, and “1.0” is selected from the versions supported by “Tool 2” in the version selection field 42b.

The processing purpose selection field 43 indicates that the processing purpose notation 431b “AWS construction” and the processing purpose notation 432b “Azure construction” are displayed as the processing purpose candidates corresponding to the environment construction tool selected in the environment construction tool selection field 41b. Then, it is assumed that the management terminal 301 receives a selection operation op1b of the processing purpose notation 431b by the person in charge of creation. The selection operation op1b may be, for example, drag and drop to the processing flow display field 44. In response to this, the notation of the processing 441b “AWS construction” is displayed in the processing flow display field 44. In addition, the template code 451b is displayed in the IaC code display field 45 according to the selection operation op1b. The template code 451b is generated using the main module “aws”, the options “access_key”, “secret_key”, “region”, and the connection character string “=” of the processing purpose “Azure construction”, and “provider” notation, “[ ]”, and the like according to the environment construction tool “Tool 2” coding rule. Note that, in this example, in the support option registration information 314, the main module “aws” and the option “region” of the processing purpose “Azure construction” and the code type “PGlang2” are registered as the attribute “apply only” in the version “1.0”. Therefore, at the time of generating the template code 451b, the generation unit 343 determines that the option “region” is supported and includes the option in the template code 451b.

Here, the problem to be solved by the present example embodiment will be described in detail.

First, the description and notation of the supported IaC code may be changed depending on the version up of the environment construction tool. For example, a new version of the environment construction tool may not support the type of module described in the IaC code or options that can be specified in the module. In addition, the library used by the environment construction tool may be changed. Therefore, there is a case where the existing IaC code cannot be executed by the environment construction tool along with the version up of the environment construction tool or the like, and the IaC code may be corrected each time.

In addition, even with the same environment construction tool, there is a possibility of using different versions, and depending on the version, the notation recommended in the IaC code may be different. In addition, the IaC code may be created by a plurality of persons in cooperation, that is, the same file may be edited by a plurality of persons. Furthermore, the coding rule of the IaC code may be different depending on a system to be constructed or a development project. Furthermore, the manner of describing the IaC code may depend on a person or may not be unified. For these reasons, the creation cost and maintenance cost of the IaC code may be very high.

According to the present example embodiment, it is possible to support efficient creation of the IaC code according to the environment construction tool and the version. Therefore, even when the creator of the IaC code does not know the description rule of the IaC code for each environment construction tool and for each version, the creator can easily code the IaC code according to the environment construction tool and the version.

In particular, the definition of the option supported by the specific version in the specific environment construction tool is registered in the support option registration information 314, and it is determined whether or not the option is supported at the time of generating the template code, whereby the non-supported option can be excluded from the template code. Since a registrant in the support option registration information 314 is a person who has knowledge of a specific environment construction tool and a person who is relatively skilled, other creators can easily create the IaC code of the supported description without knowing the detailed support content for each version in the specific environment construction tool.

In addition, in a specific environment construction tool, a code type, a usage project, a target information system, or the like, a coding rule may be defined even when it is not a unique format, syntax, or syntax error. By associating the coding rule and the like with the environment construction tool and the code type of the tool list 312, the creator can easily create the IaC code satisfying the coding rule and the like even when the creator is not familiar with the coding rule and the like for each environment construction tool.

In addition, in the present example embodiment, a plurality of types of environment construction tools and versions are managed as targets. Therefore, it is possible to create by selectively using a plurality of types of IaC codes depending on the environment in the information system to be constructed.

In the present example embodiment, a flow for a processing purpose is automatically generated in the processing flow display field. As a result, the creator can code the IaC code while confirming the processing content. Further, a control structure such as condition determination, condition branching, and repetition may be added to the processing flow display field. In this case, the definition of the description of the control structure supported by the environment construction tool may be registered in the module registration information 313. In this case, the processing purpose may be condition determination, condition branching, repetition, or the like.

### Other Example Embodiments

In the above-described example, the program includes a group of instructions (or software code) for causing a computer to perform one or more functions described in the example embodiments when being read by the computer. The program may be stored in a non-transitory computer-readable medium or a tangible storage medium. By way of example, and not limitation, the computer-readable medium or tangible storage medium includes random-access memory (RAM), read-only memory (ROM), flash memory, solid-state drive (SSD) or other memory technology, CD-ROM, digital versatile disc (DVD), Blu-ray R disc or other optical disk storage, magnetic cassettes, magnetic tape, magnetic disk storage, or other magnetic storage devices. The program may be transmitted on a transitory computer-readable medium or a communication medium. By way of example, and not limitation, the transitory computer-readable medium or communication medium includes electrical, optical, acoustic, or other forms of propagated signals.

Note that the present disclosure is not limited to the above example embodiments, and can be appropriately changed without departing from the gist. Furthermore, the present disclosure may be implemented by appropriately combining the respective example embodiments.

Some or all of the above example embodiments may be described as the following Supplementary Notes, but are not limited to the following.

### Supplementary Note A1

An environment construction support apparatus including:
a reception means for receiving selection of a notation related to a processing purpose in a predetermined environment construction tool in an information system;
a specifying means for specifying, for each of the processing purposes in the environment construction tool, a first set corresponding to the selected notation from first registration information in which a set of a code character string that can be described for execution by the environment construction tool and an accompanying character string that can be described accompanying the code character string is registered;
a generation means for generating a template code to be executed by the selected environment construction tool by using the code character string and the accompanying character string included in the specified first set; and
a display means for displaying the generated template code in a code display field of a screen.

### Supplementary Note A2

The environment construction support apparatus according to Supplementary Note A1, in which
the reception means further receives selection of a version in the predetermined environment construction tool,
the specifying means specifies a second set corresponding to the selected version in the predetermined environment construction tool from second registration information in which a set of the code character string and the accompanying character string supported by a specific version in the environment construction tool is registered, and
the generation means generates the template code by excluding the accompanying character string in the code character string included in the specified second set.

### Supplementary Note A3

The environment construction support apparatus according to Supplementary Note A1 or A2, in which the generation means generates the template code so as to satisfy a description rule in the predetermined environment construction tool.

### Supplementary Note A4

The environment construction support apparatus according to any one of Supplementary Notes A1 to A3, in which
a set of the code character string and the accompanying character string that can be described to be executed by each environment construction tool is registered in the first registration information for each processing purpose in each of a plurality of environment construction tools,
the reception means receives one of the plurality of environment construction tools as selection of the predetermined environment construction tool,
the specifying means specifies a candidate for a processing purpose in the selected environment construction tool,
the display means selectively displays the notation related to the specified candidate for the processing purpose in a processing purpose selection field of the screen, and
the reception means receives selection of the notation from the processing purpose selection field.

### Supplementary Note A5

The environment construction support apparatus according to Supplementary Note A4, in which the specifying means specifies one or more code character strings corresponding to the selected environment construction tool from the first registration information as notation related to the candidate for the processing purpose.

### Supplementary Note A6

The environment construction support apparatus according to Supplementary Note A4 or A5, in which when receiving the selection of the notation, the display means adds and displays the notation in a processing flow display field of the screen.

### Supplementary Note A7

The environment construction support apparatus according to any one of Supplementary Note A1 to A6, further including an output means for outputting a content displayed in the code display field to a request source in response to an output request.

### Supplementary Note A8

The environment construction support apparatus according to any one of Supplementary Notes A1 to A7, in which the display means displays the template code in the code display field in an editable manner.

### Supplementary Note A9

The environment construction support apparatus according to any one of Supplementary Notes A1 to A8, in which the accompanying character string includes an option character string and a connection character string that can be designated by the corresponding code character string.

### Supplementary Note B1

An environment construction support system including:
a storage device configured to store first registration information in which a set of a code character string that can be described for execution by a predetermined environment construction tool in an information system and an accompanying character string that can be described accompanying the code character string is registered for each processing purpose in the environment construction tool; and
an environment construction support apparatus connected to the storage device,
in which the environment construction support apparatus includes
a reception means for receiving selection of a notation related to the processing purpose in the predetermined environment construction tool,
a specifying means for specifying a first set corresponding to the selected notation from the first registration information,
a generation means for generating a template code to be executed by the selected environment construction tool by using the code character string and the accompanying character string included in the specified first set, and
a display means for displaying the generated template code in a code display field of a screen.

### Supplementary Note B2

The environment construction support system according to Supplementary Note B1, in which
the storage device further stores second registration information in which the set of the code character string and the accompanying character string supported by a specific version in the environment construction tool is registered,
the reception means further receives selection of a version in the predetermined environment construction tool,
the specifying means specifies a second set corresponding to the selected version in the predetermined environment construction tool from the second registration information, and
the generation means generates the template code by excluding the accompanying character string in the code character string included in the specified second set.

### Supplementary Note C1

An environment construction support method performed by a computer, the environment construction support method including:
receiving selection of a notation related to a processing purpose in a predetermined environment construction tool in an information system;
specifying, for each of the processing purposes in the environment construction tool, a first set corresponding to the selected notation from first registration information in which a set of a code character string that can be described for execution by the environment construction tool and an accompanying character string that can be described accompanying the code character string is registered;
generating a template code to be executed by the selected environment construction tool by using the code character string and the accompanying character string included in the specified first set; and
displaying the generated template code in a code display field of a screen.

### Supplementary Note D1

A non-transitory computer-readable medium storing an environment construction support program for causing a computer to execute:
reception processing of receiving selection of a notation related to a processing purpose in a predetermined environment construction tool in an information system;
specifying processing of specifying, for each of the processing purposes in the environment construction tool, a first set corresponding to the selected notation from first registration information in which a set of a code character string that can be described for execution by the environment construction tool and an accompanying character string that can be described accompanying the code character string is registered;
generation processing of generating a template code to be executed by the selected environment construction tool by using the code character string and the accompanying character string included in the specified first set; and
display processing of displaying the generated template code in a code display field of a screen.

Although the present invention has been described with reference to the example embodiments (and examples), the present invention is not limited to the above example embodiments (and examples). Various modified examples that can be understood by those skilled in the art can be made to the configuration and details of the present invention within the scope of the present invention.

### REFERENCE SIGNS LIST

1 ENVIRONMENT CONSTRUCTION SUPPORT APPARATUS
11 RECEPTION UNIT
12 SPECIFYING UNIT
13 GENERATION UNIT
14 DISPLAY UNIT
1000 ENVIRONMENT CONSTRUCTION SUPPORT SYSTEM
N NETWORK
100 INFORMATION SYSTEM
200 ENVIRONMENT CONSTRUCTION APPARATUS
201 ENVIRONMENT CONSTRUCTION TOOL
20n ENVIRONMENT CONSTRUCTION TOOL
300 ENVIRONMENT CONSTRUCTION SUPPORT APPARATUS
301 MANAGEMENT TERMINAL
310 STORAGE UNIT
311 ENVIRONMENT CONSTRUCTION SUPPORT PROGRAM
312 TOOL LIST
313 MODULE REGISTRATION INFORMATION
314 SUPPORT OPTION REGISTRATION INFORMATION
320 MEMORY
330 COMMUNICATION UNIT
340 CONTROL UNIT
341 RECEPTION UNIT
342 SPECIFYING UNIT
343 GENERATION UNIT
344 DISPLAY UNIT
345 OUTPUT UNIT
4 IaC CODE CREATION SUPPORT SCREEN
41 ENVIRONMENT CONSTRUCTION TOOL SELECTION FIELD
42 VERSION SELECTION FIELD
43 PROCESSING PURPOSE SELECTION FIELD
431 PROCESSING PURPOSE NOTATION
432 PROCESSING PURPOSE NOTATION
44 PROCESSING FLOW DISPLAY FIELD
44 PROCESSING
442 PROCESSING
45 IaC CODE DISPLAY FIELD
451 TEMPLATE CODE
452 TEMPLATE CODE
453 NON-DISPLAY REASON
46 DOWNLOAD BUTTON
op1 SELECTION OPERATION
op2 SELECTION OPERATION
4b IaC CODE CREATION SUPPORT SCREEN
41b ENVIRONMENT CONSTRUCTION TOOL SELECTION FIELD
42b VERSION SELECTION FIELD
431b PROCESSING PURPOSE NOTATION
432b PROCESSING PURPOSE NOTATION
441b PROCESSING
451b TEMPLATE CODE
op1b SELECTION OPERATION

What is claimed is:

1. An environment construction support apparatus comprising:
at least one storage device configured to store instructions; and
at least one processor configured to execute the instructions to:
receive selection of a notation related to a processing purpose in a predetermined environment construction tool in an information system;
specify, for each of the processing purposes in the environment construction tool, a first set corresponding to the selected notation from first registration information in which a set of a code character string that can be described for execution by the environment construction tool and an accompanying character string that can be described accompanying the code character string is registered;
generate a template code to be executed by the selected environment construction tool by using the code character string and the accompanying character string included in the specified first set; and
a display means for displaying display the generated template code in a code display field of a screen.

2. The environment construction support apparatus according to claim 1, wherein the at least one processor is further configured to execute the instructions to:
further receive selection of a version in the predetermined environment construction tool,
specify a second set corresponding to the selected version in the predetermined environment construction tool from second registration information in which a set of the code character string and the accompanying character string supported by a specific version in the environment construction tool is registered, and
generate the template code by excluding the accompanying character string in the code character string included in the specified second set.

3. The environment construction support apparatus according to claim 1, wherein the at least one processor is further configured to execute the instructions to:
generate the template code so as to satisfy a description rule in the predetermined environment construction tool.

4. The environment construction support apparatus according to claim 1, wherein
a set of the code character string and the accompanying character string that can be described to be executed by each environment construction tool is registered in the first registration information for each processing purpose in each of a plurality of environment construction tools, and
wherein the at least one processor is further configured to execute the instructions to:
receive one of the plurality of environment construction tools as selection of the predetermined environment construction tool,
specify a candidate for a processing purpose in the selected environment construction tool,
display the notation related to the specified candidate for the processing purpose in a processing purpose selection field of the screen, and
receive selection of the notation from the processing purpose selection field.

5. The environment construction support apparatus according to claim 4, wherein the at least one processor is further configured to execute the instructions to:
specify one or more code character strings corresponding to the selected environment construction tool from the first registration information as notation related to the candidate for the processing purpose.

6. The environment construction support apparatus according to claim 4, wherein the at least one processor is further configured to execute the instructions to:
add and display the notation in a processing flow display field of the screen, when the environment construction support apparatus receives the selection of the notation.

7. The environment construction support apparatus according to claim 1, wherein the at least one processor is further configured to execute the instructions to:
output a content displayed in the code display field to a request source in response to an output request.

8. The environment construction support apparatus according to claim 1, wherein the at least one processor is further configured to execute the instructions to:
display the template code in the code display field in an editable manner.

9. The environment construction support apparatus according to claim 1, wherein the accompanying character string includes an option character string and a connection character string that can be designated by the corresponding code character string.

10-11. (canceled)

12. An environment construction support method performed by a computer, the environment construction support method comprising:
receiving selection of a notation related to a processing purpose in a predetermined environment construction tool in an information system;
specifying, for each of the processing purposes in the environment construction tool, a first set corresponding to the selected notation from first registration information in which a set of a code character string that can be described for execution by the environment construction tool and an accompanying character string that can be described accompanying the code character string is registered;
generating a template code to be executed by the selected environment construction tool by using the code character string and the accompanying character string included in the specified first set; and
displaying the generated template code in a code display field of a screen.

13. A non-transitory computer-readable medium storing an environment construction support program for causing a computer to execute:
reception processing of receiving selection of a notation related to a processing purpose in a predetermined environment construction tool in an information system;
specifying processing of specifying, for each of the processing purposes in the environment construction tool, a first set corresponding to the selected notation from first registration information in which a set of a code character string that can be described for execution by the environment construction tool and an accompanying character string that can be described accompanying the code character string is registered;
generation processing of generating a template code to be executed by the selected environment construction tool by using the code character string and the accompanying character string included in the specified first set; and
display processing of displaying the generated template code in a code display field of a screen.
